(19) United States
(12) Patent Application Publication
(10) Pub. No.: US 2009/0102843 A1
(43) Pub. Date: Apr. 23, 2009

(54) IMAGE-BASED PROXY ACCUMULATION FOR REALTIME SOFT GLOBAL ILLUMINATION

(75) Inventors: Peter-Pike J. Sloan, Bellevue, WA (US); Naga K. Govindaraju, Redmond, WA (US); Derek Nowrouzezahrai, Ontario (CA); John M. Snyder, Redmond, WA (US)

Correspondence Address: MICROSOFT CORPORATION, ONE MICROSOFT WAY, REDMOND, WA, 98052, US

(73) Assignee: MICROSOFT CORPORATION, Redmond, WA (US)

(21) Appl. No.: 11/873,646

(22) Filed: Oct. 17, 2007

(51) Int. Cl. G06T 15/50

(52) U.S. Cl. 345/426

(57) ABSTRACT

General and realtime technique for soft global illumination in low-frequency environmental lighting. The technique accumulates over a relatively few spherical proxies that approximate the light blocking and re-radiating effect of dynamic geometry. Soft shadows are computed by accumulating log visibility vectors for each sphere proxy as seen by each receiver point. Inter-reflections are computed by accumulating vectors representing the proxy's unshadowed radiance when illuminated by the environment. Both vectors capture low-frequency directional dependence using the spherical harmonic basis. Additionally, a new proxy accumulation method splats each proxy to receiver pixels in image space to collect the proxy's contribution to shadowing and indirect lighting. A soft rendering pipeline unifies direct and indirect soft effects with an accumulation methodology that maps entirely to a graphics processing unit and outperforms previous vertex-based methods.

### BACKGROUND

Advances in hardware and software related to computer graphics drive a lucrative segment of the industry. For example, the computer games market is now a multi-billion dollar industry. Users demand to have the fastest computing systems to provide unhindered speed and optimum rendering for the experience. Accordingly, vendors compete to provide the best user experience possible with the available hardware and software technology.

Global illumination (GI) effects such as soft shadows and inter-reflections greatly enhance realism but are challenging to render in realtime. Previous approaches capture only hard shadows from point or small area lights, or render soft effects only in static scenes. Hard shadow techniques can be extended to render soft shadows by numerically integrating over many light directions constituting the area light source. Unfortunately, these techniques do not generate soft shadows in realtime because integrating over a large light source area impedes processing by requiring a high number directional samples and a correspondingly high number of rendering passes.

One conventional realtime approach for computing soft shadows uses shadow and illumination fields. Shadow fields describe the shadowing effects of an individual scene entity at sampled points in surrounding volumetric space. The illumination field for a local light source is referred to as a source radiance field (SRF). The SRF includes cube maps that record incoming light from the illuminant at sample points in the surrounding volumetric space. An infinitely-distant environment map is a special case that can then be represented as a single SRF cube map. Each object in the scene is represented by an object occlusion field (OOF). The OOF records the occlusion of radiance by the object as viewed from sample points around the object. The soft shadows are then computed at runtime by rotating each blocker visibility function into the local coordinate frame and computing the spherical harmonic product over all of the blockers. While this technique improves the generation of soft shadows in dynamic scenes, the technique is still too computationally complex (e.g., spherical harmonics rotation and products) to allows the soft shadows to be efficiently generated when there are several objects moving in the scene.

### SUMMARY

The following presents a simplified summary in order to provide a basic understanding of some novel embodiments described herein. This summary is not an extensive overview, and it is not intended to identify key/critical elements or to delineate the scope thereof. Its sole purpose is to present some concepts in a simplified form as a prelude to the more detailed description that is presented later.

The disclosed architecture includes general and realtime technique for soft global illumination (GI) in low-frequency environmental lighting. The technique accumulates over relatively few blocker proxies (e.g., spherical in shape) that approximate the light blocking and re-radiating effect of dynamic geometry.

Soft shadows are computed by accumulating log visibility vectors for each proxy as seen by each receiver point. Inter-reflections are computed by accumulating vectors representing the proxy's unshadowed radiance when illuminated by the environment. Both vectors capture low-frequency directional dependence using the spherical harmonic basis. Additionally, a new proxy accumulation strategy is presented that splats each proxy to receiver pixels in image space to collect the proxy's contribution to shadowing and indirect lighting.

The disclosed soft GI rendering pipeline unifies direct and indirect soft effects with a simple accumulation strategy that maps entirely to the graphics processing unit (GPU) and outperforms previous vertex-based methods.

To the accomplishment of the foregoing and related ends, certain illustrative aspects are described herein in connection with the following description and the annexed drawings. These aspects are indicative, however, of but a few of the various ways in which the principles disclosed herein can be employed and is intended to include all such aspects and equivalents. Other advantages and novel features will become apparent from the following detailed description when considered in conjunction with the drawings.

### BRIEF DESCRIPTION OF THE DRAWINGS

FIG. 1 illustrates computer-implemented illumination system for realtime soft global illumination.

FIG. 2 illustrates proxy accumulation and shading using a set of spherical proxies from environmental light in all directions.

FIG. 3 illustrates processes in a general accumulation pipeline for rendering shadowed and indirect radiance results for a receiver point.

FIG. 4 illustrates bounds associated with splatting a proxy's sphere of influence.

FIG. 5 illustrates a GPU that can process image-based proxy accumulation for realtime soft global illumination.

FIG. 6 illustrates a computer-implemented method of illuminating an image.

FIG. 7 illustrates a method of moving low-resolution lighting information to display resolution.

FIG. 8 illustrates a method of accumulating indirect radiance from a proxy sphere.

FIG. 9 illustrates a block diagram of a computing system operable to execute soft global illumination using image-based proxy accumulation in accordance with the disclosed architecture.

### DETAILED DESCRIPTION

The disclosed architecture targets soft global illumination (GI) effects in dynamic scenes (e.g., including moving characters) in low-frequency lighting environments. An algorithm is described for accumulating indirect radiance from blocker proxies (e.g., spherical) in environmental lighting, which ensures arbitrary proxy overlap does not yield unbounded radiance.

In one embodiment, the dynamic geometry is first approximated as a set of spheres used as proxies for how that geometry blocks and re-radiates light. Rays around a receiver point are considered in all directions simultaneously using a spherical harmonic (SH) basis to represent proxy visibility and indirect radiance. Small SH vectors (e.g., with an order of four that yield 16D vectors) make the computation practical and are sufficient for realistic soft effects. The total shadowed result plus the indirectly illuminated result are computed by accumulating vectors over all proxies at each receiver point. Moreover, the proxies are accumulated in image (or screen) space rather than in object space (over mesh vertices) or texture space (using a surface parameterization).

Soft shadows are computed by accumulating logarithmic (“log”) visibility vectors for each sphere proxy as seen by each receiver point (or location). Each pixel represents a receiver location for accumulating GI proxies. Thus, shading computation takes place only where it is visible. When upsampling the shading results, bilateral filtering is applied to avoid interpolating over discontinuities in the depth or normal of a receiver point. Inter-reflections are computed by accumulating vectors representing the proxy's unshadowed radiance when illuminated by the environment. Both vectors capture low-frequency directional dependence using the spherical harmonic basis.

The proxy accumulation strategy splats each proxy to receiver pixels in image space to collect the contribution of shadowing and indirect lighting. The “feed-forward” design splats the contributions of the spheres directly into screen space which effectively means all the pixels that are touched then all run the exact same shader, and thus, more efficient for the graphics processing unit (GPU).

The disclosed image-based SH proxy accumulation approaches is implementable entirely on the GPU. The sampling rate is also decoupled from the sampling rate of the display. The approach handles more GI effects, maps better to GPUs, provides higher-quality sampling, and is many times faster than previous object-based techniques. The approach is a computer graphics technology that can be used in 3D games and other realtime applications that image geometric models (e.g., web shopping, home customization).

Reference is now made to the drawings, wherein like reference numerals are used to refer to like elements throughout. In the following description, for purposes of explanation, numerous specific details are set forth in order to provide a thorough understanding thereof. It may be evident, however, that the novel embodiments can be practiced without these specific details. In other instances, well-known structures and devices are shown in block diagram form in order to facilitate a description thereof.

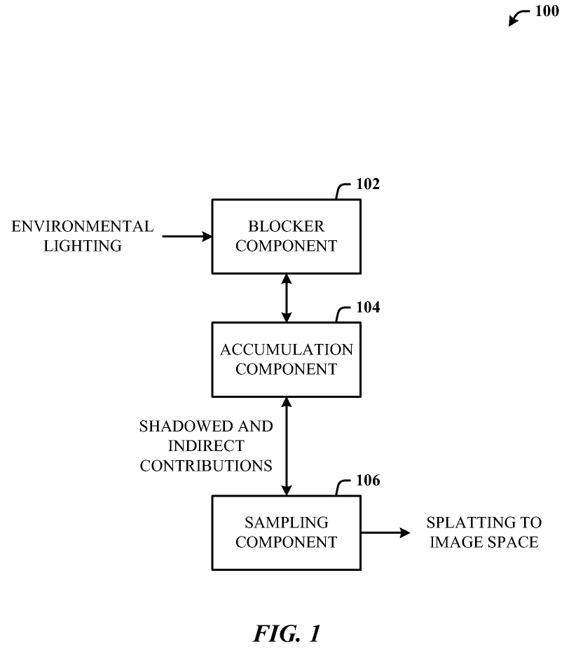

FIG. 1 illustrates computer-implemented illumination system 100 for realtime soft global illumination. The system 100 includes a blocker component 102 for approximating dynamic geometry of a scene using blocker proxies that represent effects by the geometry on environmental light received at a receiver point in the scene, and an accumulation component 104 for splatting each blocker proxy to a receiver pixel in image space to accumulate shadowing and indirect lighting contribution of the blocker proxy at the receiver pixel. A sampling component 106 samples at less than the display resolution and then upsamples the lighting effects to image space based on occlusion vectors and indirect shading. In one embodiment, the blocker proxies are spherical proxies and the lighting effects are computed as logarithmic visibility vectors of the spherical proxies. Accumulation of the logarithmic visibility vectors captures low-frequency directional dependence of environmental light. The accumulation component 104 accumulates the logarithmic visibility vectors of the lighting effects of the environmental light from all directions on a receiver point from all blocker proxies using the spherical harmonic basis to represent shadowing, and indirect radiance vectors that represent radiance of the proxies that is re-radiated onto the receiver point from all the blocker proxies.

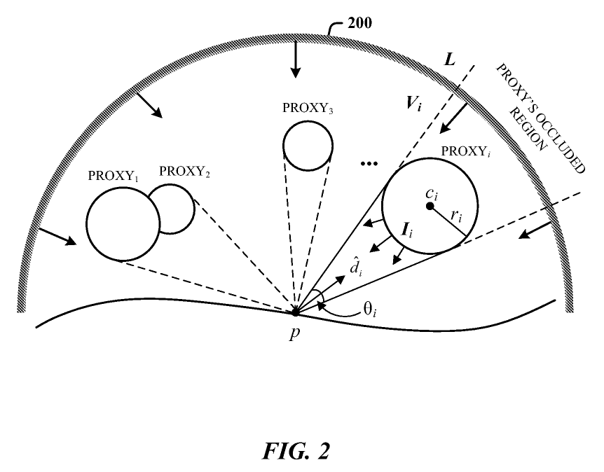

FIG. 2 illustrates proxy accumulation and shading using a set of spherical proxies from environmental light 200 in all directions. Proxy accumulation and shading takes place at each receiver point, denoted p. Receiver points are represented in image space as pixels containing a position and normal vector. A set of m proxy spheres (denoted PROXY₁, PROXY₂, . . . , PROXYᵢ) are used to block and shed indirect lighting at p; sphere i has center cᵢ and radius rᵢ. The distance from the receiver point p to the proxy center is dᵢ=∥cᵢ−p∥ and associated direction \hat{d}ᵢ=(cᵢ−p)/dᵢ. The distance to the closest point on the sphere is denoted \tilde{d}ᵢ=dᵢ−rᵢ. The half-angle subtended by the proxy at p is,

sin θᵢ=rᵢ/dᵢ=αᵢ, (1)

and its corresponding solid angle is denoted,

ωᵢ=2π(1−cos θᵢ)=2π(1−\sqrt{1−αᵢ²}) (2)

The proxy visibility function as seen from p is denoted Vᵢ (s), defined via:

$${V}_{i} ( s ) = \{ \begin{matrix}1 , & if s \cdot {\hat{d}}_{i} \geq cos {θ}_{i} , \\ 0 , & otherwise .\end{matrix} \qquad ( 3 )$$

where sεS={(sₓ, s_{y}, s_{z})|sₓ²+s_{y}²+s_{z}²=1} is a point on the sphere S, representing a direction emanating from p. The SH vector representing visibility is denoted Vᵢ. Bolded text is used to denote SH vectors throughout this description.

Occlusion is defined for each proxy that represents visibility of the distant environment rather than the proxy itself, denoted

Oᵢ=1−Vᵢ=(\sqrt{4π}, 0, . . . , 0)−Vᵢ

where the SH vector 1 represents the constant 1 over the sphere and has only its first (DC) coefficient nonzero, denoted 1₀=\sqrt{4π}. Note that ωᵢ=Vᵢ·1=(Vᵢ)₀\sqrt{4π}.

The total occlusion function over all proxies is denoted by Oₚ(s), and its SH projection Oₚ. The total occlusion vector, accounting for overlap, can be computed from the sum of the individual log occlusion vectors, denoted Oᵢ^{log}, via:

$${O}_{p} \approx {O}_{1} * {O}_{2} * ⋯ * {O}_{m} \approx exp ( {\sum }_{i = 1}^{m} {O}_{i}^{log} ) . \qquad ( 4 )$$

This is an instance of a standard engineering trick that converts a chain of products into a sum of logs. In this case, visibility is accumulated using m−1 simple vector adds instead of expensive SH products, at the cost of evaluating a single SH exponential. The benefits increase as the number of proxies m grows. A hybrid (HYB) method is adopted for the SH exponential. The HYB method applies scaling/squaring to an optimal linear (OL) approximation in lieu of employing an SH product. The HYM method divides the input by a power of two, applies the OL approximation, and then repeatedly squares the result.

Scaling/squaring is a technique used to evaluating scalar (and matrix) exponentials, which observes that,

$$exp ( x ) = {( exp ( \frac{x}{{2}^{p}} ) )}^{{2}^{p}} ⇒ {exp}_{*} ( f ) \approx {( {exp}_{*} ( \frac{f}{{2}^{p}} ) )}^{{2}^{p} *}$$

where p is a positive integer. In other words, to compute exp(x), first divide the input x by a power of two, compute the exponential of this scaled input, and repeatedly square the result p times. This can also be applied to SH exponentiation using p repeated squarings via the recurrence ƒ²^{^{p}}*=ƒ²^{^{p−1}}**ƒ²^{^{p−1}}*.

For SH order-4 or lower, an extension of a simple 2-term series

$${exp}_{*} ( f ) \approx 1 + f from {exp}_{*} ( f ) = 1 + f + \frac{{f}^{2 *}}{2} + \frac{{f}^{3 *}}{3 !} + …$$

provides good accuracy without the need for an SH product. Given an input vector f to be exponentiated, DC isolation is applied to obtain \hat{ƒ}, then computing its magnitude ∥\hat{ƒ}∥, followed by,

$${exp}_{*} ( f ) \approx exp ( \frac{{f}_{0}}{\sqrt{4 π}} ) ( a ( ‖ \hat{f} ‖ ) 1 + b ( ‖ \hat{f} ‖ ) \hat{f} )$$

where the coefficients a and b are determined by generating a set of SH vector pairs representing circles of increasing angular radius; one vector in the pair is the visibility function g and the other, its corresponding logarithmic vector ƒ.

To account for DC isolation, the DC component of vector ƒ is zeroed out to obtain \hat{ƒ}, and correspondingly scale g to obtain ĝ=exp(−ƒ₀/\sqrt{4π})g. Finally, the least-squares best projection of ĝ onto the orthogonal vectors 1 and \hat{ƒ} is found via

$$a = \frac{\hat{g} \cdot 1}{1 \cdot 1} = \frac{{\hat{g}}_{0}}{\sqrt{4 π}} , b = \frac{\hat{g} \cdot \hat{f}}{\hat{f} \cdot \hat{f}}$$

providing the minimum error ∥ĝ−(a1+b\hat{ƒ})∥. Least-squares projection is performed for each circle of a different angular radius, and the resulting a and b coefficients are tabulated as a function of ∥\hat{ƒ}∥, which increases with angular radius.

Indirect accumulation also uses the summed solid angle of the proxies,

$$denoted {ω}_{p} = {\sum }_{i = 1}^{m} {ω}_{i} .$$

With respect to spherical harmonics, let ƒ(s) be a spherical function, represented by the doubly indexed SH vector ƒₗₘ. It is often convenient to consider these vectors as singly indexed as well, as in ƒₗ. SH vectors of order n have n² components. Let g(s) be a circularly symmetric function about z=(0, 0, 1). Then g can be represented by a zonal harmonic (ZH) vector gₗ having nonzero coefficients only for m=0. Projecting a spherical function ƒ(s) to an SH vector ƒ involves integration against the SH basis functions y:

$${f}_{lm} = {\int }_{s ∈ S}^{ } f ( s ) {y}_{lm} ( s ) d s . \qquad ( 5 )$$

Evaluating ƒ at the spherical point s is computed via

$$f ( s ) = {\sum }_{lm} {f}_{lm} {y}_{lm} ( s ) . \qquad ( 6 )$$

Convolving ƒ by g yields:

$${( f ★ g )}_{lm} = \sqrt{\frac{4 π}{2 l + 1}} {f}_{lm} {g}_{l} = Cg ( f ) \qquad ( 7 )$$

where C_{g} is a diagonal matrix that repeats l times each component gₗ, scaled by

$$\sqrt{\frac{4 π}{2 l + 1}} .$$

Rotating g from its canonical center at z to an arbitrary one z′ is computed via

$${rot ( g , {z}^{′} )}_{lm} = \sqrt{\frac{4 π}{2 l + 1}} {g}_{l} {y}_{lm} ( {z}^{′} ) . \qquad ( 8 )$$

The product of two spherical functions represented by two SH vectors is denoted ƒ₁*ƒ₂, and involves applying the order-3 triple product tensor to the two input vectors. The SH triple product tensor, [symbol] ᵢⱼₖ, is defined by,

$$= {\int }_{s} {y}_{i} ( s ) {y}_{j} ( s ) {y}_{k} ( s ) d s .$$

where [symbol] is a symmetric, sparse, order-3 tensor.

With respect to shading in spherical harmonics, distant environment light 200 is represented by the spherical function L(s) and SH vector L. Unshadowed shading from this light 200 onto a diffuse receiver (i.e., irradiance) is denoted \tilde{L}=L★ g_{cos}=Cg_{cos}L. It can be computed via equation (7) by convolving with the clamped cosine function around z: g_{cos}(s)=max(0, s_{z}). Indirect radiance from proxy i as seen by receiver point p is denoted Iᵢ(s) and SH vector Iᵢ. Total indirect radiance at receiver point p is denoted Iₚ and is computed by normalizing the summed indirect radiance

$${\tilde{I}}_{p} = {\sum }_{i} {I}_{i} .$$

Final incident radiance at receiver point p is shadowed direct illumination plus indirect illumination:

Lₚ=Oₚ*L+Iₚ. (9)

This involves two accumulations over the proxy set at each receiver point p: one for log occlusion Oₚ and one for indirect radiance Iₚ. These accumulation steps will be further detailed hereinafter.

Given a receiver point p and a spherical proxy, Oᵢ^{log} is computed using a 1D (one dimensional) table which stores log visibility ZH vectors for a canonically positioned sphere (centered along the z axis) as a function of αᵢ=sin θᵢ. Equation (8) then allows the tabulated vector corresponding to the angle subtended by the proxy at receiver point p to be rotated to its actual direction z′=\hat{d}ᵢ. Self-shadowing by proxies that contain receiver point p or intersect the tangent plane of receiver point p can be handled with special replacement rules.

Assuming a diffuse surface with normal vector Nₚ, the shade at p is given by

Ψₚ=H(Nₚ)·Lₚ=Oₚ·\tilde{L}(Nₚ)+Iₚ19 H(Nₚ) (10)

where H (Nₚ)=rot(g_{cos}, Nₚ) represents the diffuse bi-directional reflection distribution functions (BRDF): a clamped cosine around the normal.

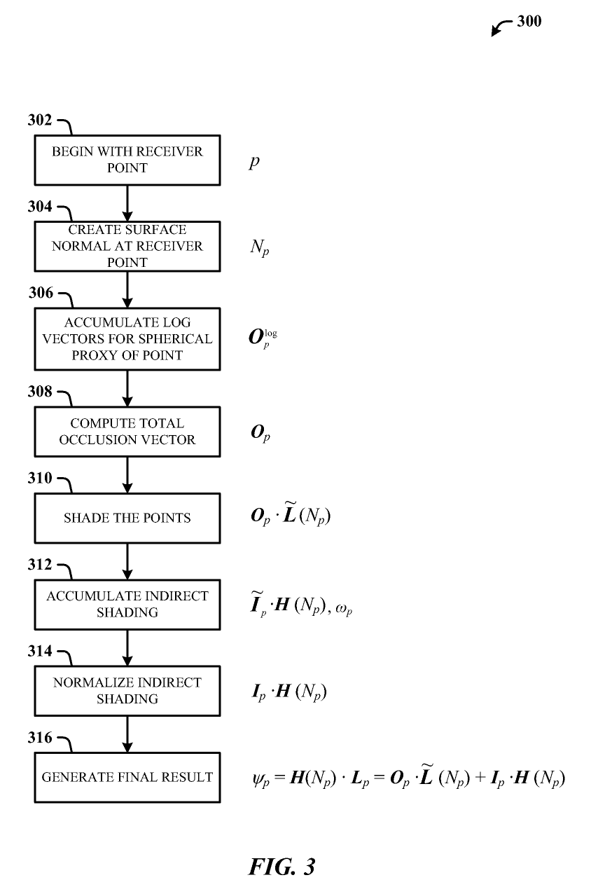

FIG. 3 illustrates processes in a general accumulation pipeline 300 for rendering shadowed and indirect radiance results for a receiver point. Successive passes are visualized from top to bottom. Rendering begins with a receiver point p, at 302, followed by the surface normal Nₚ of the receiver point p, at 304. At 306, log vectors for a blocker (e.g., spherical proxy) of the receiver point p are accumulated. At 308, the total occlusion vector is computed. At 310, points are shaded. Indirect shading is then accumulated, at 312. At 314, the indirect shading is normalized, and at 316, the final result generated.

More specifically, the pipeline 300 begins with a first receiver setup pass which rasterizes the 3D receiver point p=(pₓ, p_{y}, p_{z}) along with its normal Nₚ at each pixel of a low-resolution image called the receiver buffer, as well as to the higher display resolution. Typically, the receiver buffer is ½ or ¼ of the display's resolution in both x and y. A shader transforms the point/normal pair (p, Nₚ) to two separate buffers: a first buffer stores the receiver point p and a second buffer stores a 4D vector (Nₚ, zₚ), where zₚ=(p−e)·E represents the eye-space depth of receiver point p given eye point e and image plane normal E. The algorithm provides robust upsampling of the coarsely sampled shading at the low resolution image using bilateral filtering.

Following the receiver setup pass are two accumulation passes that splat the proxies to the receiver buffer to sum shadowing and indirect reflection. A coverage oracle, based on a conservative sphere of influence for each proxy, ensures proxies are splatted only where necessary.

An exponentiation pass then computes the SH exponential of the accumulated log visibility to obtain Oₚ. This result is dot product with the lighting, yielding the first term in equation (10). Indirect radiance is then accumulated and added to this result.

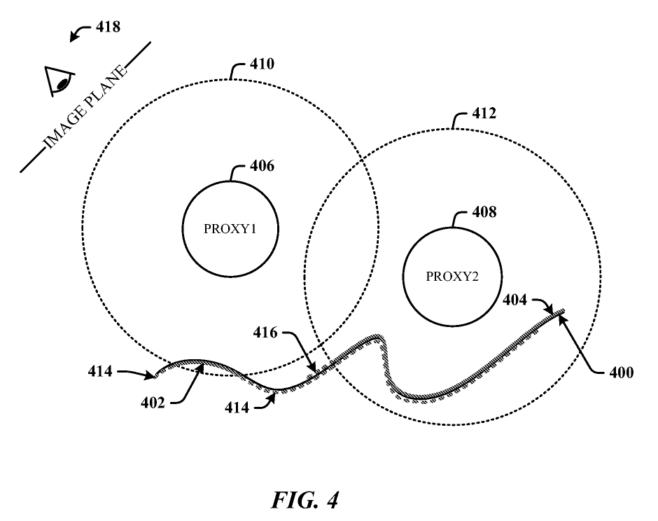

FIG. 4 illustrates bounds associated with splatting a proxy's sphere of influence. The coverage oracle bounds each proxy's sphere of influence, representing the region of receiver points that possibly receive a contribution from the proxy sphere. While this region is technically infinite, a proxy's contribution falls off rapidly with distance. The proxy contribution can be approximated by expanding the proxy's radius by a fixed factor denoted a. Splatting the proxy's sphere of influence then accumulates its contribution at all relevant receiver points on a receiver surface 400 (solid back line). A first solid line 402 on the receiver surface 400 and a second solid line 404 on the receiver surface 400 represent proxy splats from a corresponding first proxy 406 and a corresponding second proxy 408. The solid lines (402 and 404) represent points which pass the depth test, and thus, are inside a respective first sphere of influence 410 and a second sphere of influence 412. The first dashed line portions 414 show where the first proxy splat 406 fails the depth test when outside the first sphere of influence 410. Similarly, the second dashed line potion 416 show where the second proxy splat 408 fails the depth test when outside the second sphere of influence 412.

For shadowing on diffuse surfaces, a conservative expansion factor is obtained assuming lighting via a delta function, which is the “peakiest” light representable at the given SH order n. The receiver normal is further assumed to point directly toward the strongest light direction. The light vector is normalized so that unshadowed shading maps to a unit result Oust reaches saturation). Given this conservative configuration, the sphere of influence is chosen so that receiver points outside the sphere of influence yield no more than a small difference between shadowed and unshadowed shading. For SH order-4, an expansion factor of roughly η=15 (equivalent to a half angle θ=3.80°) yields a shading difference on the order of 1 in 256, suitable for 8-bit per channel rendering.

This idea can be specialized to the actual lighting environment instead of assuming the worst case. The same idea of determining the largest blocker with sufficiently small shading difference can be applied. For environments such as a cloudy sky, a smaller expansion factor can be used which decreases splat area and thus rendering cost.

Similarly, a conservative expansion factor for indirect accumulation can be derived by analyzing shading differences. When using an SH order-3, an expansion factor of η=10 suffices.

To splat the proxy, a coarsely tessellated sphere is rasterized that bounds the proxy's sphere of influence, as seen by the viewpoint 418. The depth of each covered pixel is then tested to see whether the corresponding receiver point is inside the sphere of influence. Pixels inside are processed further to accumulate shadowing or indirect illumination.

The proxy's contribution is smoothly forced to zero at the boundary of its sphere of influence. This removes a discontinuity that would otherwise arise by abruptly eliminating the proxy's blocking or inter-reflection effect. Given the radius expansion factor η, the smallest proxy supported at the receiver has half-angle sine of αᵢ=sin θᵢ=1/η. The proxy's contribution can be smoothly clamped by re-weighting the table of canonical ZH log occlusion vectors, O^{log}(αᵢ), for shadow accumulation or ZH visibility vectors, V (αᵢ), for indirect accumulation. In one implementation, four table entries around 1/η are selected and the corresponding ZH vectors are weighted smoothly to zero. Vectors for even smaller half angles are forced to zero.

After splatting the proxies and exponentiating, the receiver buffer is filled with occlusion vectors, Oₚ. Similarly, a separate pass accumulates indirect shading, Iₚ·H(Nₚ), per receiver. The vectors are upsampled to display resolution before summing in equation (10). During this upsampling, the interpolation kernel does not straddle discontinuities in the receiver geometry such as across silhouettes or over large differences in normal, for example. This situation is detected and handled using a variant of bilateral filtering. Interpolated source samples at a coarse resolution are weighted based on the difference with the depth and normal of the (finer-resolution) target pixel. In other words, source samples that are similar to the target's receiver plane can contribute.

Given the receiver plane information at the 2×2 block of coarse source samples indexed by i=1, 2, 3, 4 and the target sample at p, interpolation is performed using the four weights,

$${w}_{i} = \frac{{\tilde{w}}_{i}}{{\sum }_{j = 1}^{4} {\tilde{w}}_{j}} where {\tilde{w}}_{i} = {w}_{i}^{b} {w}_{i}^{z} {w}_{i}^{N} . \qquad ( 11 )$$

The individual weight factors are defined as

$${w}_{i}^{N} = {( {N}_{p} \cdot {N}_{i} )}^{32} and {w}_{i}^{z} = \frac{1}{∈ + \vert {z}_{p} - {z}_{i} \vert}$$

and wᵢ^{b} are the standard bilinear weights determined by the 2D position of the target relative to the source samples.

It can happen that no coarse sample sufficiently matches the target; in other words, all four unnormalized weights, \tilde{w}ᵢ, are nearly zero. This problem typically arises at very few pixels along silhouettes, assuming no objects are completely unsampled in the receiver buffer. A robust solution is to perform an additional pass which shades these few from scratch given the entire list of proxies. A cheaper solution is simply to interpolate shaded results rather than occlusion vectors which give rise to fewer artifacts when interpolated.

Indirect lighting from each proxy is modeled assuming it is directly illuminated by the environment L without shadows. A progression of three methods can be employed: an approximation which pastes radiance sampled at the proxy center over its entire visible disk, a more accurate approximation that averages shading across the entire proxy, and a linear operator producing the exact radiance distribution.

Given the indirect lighting over each proxy, compute the total by summing over all proxies, which ignores inter-proxy occlusion effects. However, the result is normalized to ensure lighting does not over-saturate when the proxies overlap, via:

$${I}_{p} = {ξ}_{p} {\tilde{I}}_{p} , where {ξ}_{p} = \frac{{( {V}_{p} )}_{0}}{{ω}_{p} / \sqrt{4 π}} . \qquad ( 12 )$$

The normalization factor ξₚ represents the ratio of the solid angle of all proxies combined (DC component of total visibility vector Vₚ=1−Oₚ where Oₚ is computed using equation (4)), to total solid angle summed over all proxies i ignoring overlap. The indirect accumulation pass thus sums the RGB (red, green, blue) components of Iᵢ·H(Nₚ) as well as the scalar solid angle ωₚ. The result is then normalized and added to the previously accumulated shadowed radiance in a final pass. Alternatively, either shaded results or an irradiance vector (e.g., quadratic-Order 3-SH) can be accumulated.

The most straightforward method, point-sampled indirect radiance, samples radiance in the direction opposite to the proxy center, −\hat{d}ᵢ, and assumes the associated entire visible disk emits this constant radiance value. The radiance vector for proxy i can thus be computed as

Iᵢ=\tilde{L}(−\hat{d}ᵢ)Vᵢ=(\tilde{L}·y(−\hat{d}ᵢ) Vᵢ. (13)

The second method, averaged indirect radiance, also assumes a constant radiance over the proxy's disk, but more accurately averages radiance across it instead of simply sampling at the center.

Assume that a ray in direction s emanating from receiver point p outside the proxy first hits the proxy at point q(s) (which implies Vᵢ(s)=1):

q(s)=p+s(−s·pᵢ−\sqrt{(s·p)²−∥pᵢ∥²+rᵢ²})

where pᵢ=p−cᵢ. Denote the normalized direction from the proxy center to q(s) as \hat{q}(s)=(qₛ−cᵢ)/rᵢ. Then unshadowed radiance at q(s) due to the environment is \tilde{L}(\hat{q}(s)) since the sphere's unit normal vector at q(s) is equal to \hat{q}(s).

Average radiance across the proxy's disk is then given by the following integral:

$$D [ \tilde{L} ] = \frac{1}{{ω}_{i}} {\int }_{s ∈ S} {V}_{i} ( s ) \tilde{L} ( \hat{q} ( s ) ) d s .$$

This is a linear operator on \tilde{L} producing a scalar, which can itself be represented as an SH vector.

If canonically orienting the proxy so that cᵢ=(0, 0, 1), p=(0, 0, 0), and rᵢ=sin θ, then this linear operator is a function of the angle subtended θ, which can be denoted as

$$D ( θ ) = \frac{1}{ω ( θ )} {\int }_{s ∈ S} {v}_{θ} ( s ) y ( {\hat{q}}_{θ} ( s ) ) d s . \qquad ( 14 )$$

For this canonical configuration,

q_{θ}(s)=s(s_{z}−\sqrt{s_{z}²−cos²θ})

and \hat{q}₀(s)=(q_{θ}(s)−(0, 0, 1))/sin θ. The canonical visibility function, v_{θ}(s), is one if and only if s_{z}≧cos θ. D is circularly symmetric around z so the only nonzero coefficients are for m=0.

The formula in equation (8) rotates D from the canonical orientation along (0,0,1) to the direction along the actual proxy, \hat{d}ᵢ. This scalar result then multiplies the proxy's visibility vector Vᵢ, yielding the final formula

i Iᵢ=κᵢVᵢ where κᵢ=rot(D(θᵢ), \hat{d}ᵢ)·\tilde{L}. (15)

The visibility vector is given by rotating a canonical visibility vector V (again oriented directly above the z axis) tabulated as a function of αᵢ:

Vᵢ=rot(V(αᵢ),\hat{d}ᵢ).

As in the case of shadowed accumulation, the table V (α) can be re-weighted given the radius expansion factor η to smoothly clamp the proxy's indirect contribution to zero at the boundary of the proxy's sphere of influence.

An analytic formula for the order-3 operator is given by:

$$D ( θ ) = ( \begin{matrix}\frac{1}{2 \sqrt{π}} , \frac{- \sqrt{3} ( 2 {d}^{3} - 2 \breve{d} {d}^{2} - \breve{d} + 1}{6 \sqrt{π} d ( d - \breve{d} )} , \\ \frac{\sqrt{5} ( 6 {d}^{5} - 6 \breve{d} {d}^{4} - 3 \breve{d} {d}^{2} - \breve{d} + 4 )}{20 \sqrt{π} {d}^{2} ( d - \breve{d} )}\end{matrix} )$$

where d=csc θ and \check{d}=\sqrt{d²−1}. These three components are very smooth functions of α=sin θ and can be accurately approximated using low-order polynomial functions. The following approximation can be employed:

D₀=0.28209

D₁≈0.08432 α²−0.25073 α−0.32494

D₂≈−0.22230 α³+0.22502 α²+0.47398 α+0.15950

With respect to the third method of exact indirect radiance, a linear operator on \tilde{L} yields the exact spherical function for radiance over the proxy. Assuming the proxy is in the same canonical orientation as in the previous subsection, the operator is solely a function of angle θ subtended by the proxy, defined by

$${M}_{jk} ( θ ) = {\int }_{s ∈ S} {v}_{θ} ( s ) {y}_{j} ( s ) {y}_{k} ( {\hat{q}}_{θ} ( s ) ) d s . \qquad ( 16 )$$

M can be evaluated analytically or by numerical integration as a preprocess operation and tabulated as a function of θ. To apply this canonical operator, the lighting is rotated into the canonical proxy's frame, the canonical operator is applied, and then the result is rotated back, via

Iᵢ=R⁻¹M(θᵢ)R\tilde{L} (17)

where R rotates the direction \hat{d}ᵢ to (0,0,1) and R⁻¹ is the inverse rotation.

As a general summary, soft GI effects can be efficiently handled by approximating geometry as a set of proxies and accumulating each proxy's contribution in image space. The disclosed architecture extends ambient occlusion splatting to higher frequencies in order to cast shadows that respond to lighting direction. The architecture also accounts for inter-reflections as well as shadows, and obtains better performance and higher-quality sampling than previous vertex-based methods.

The basic method is quite general and can be extended to other GI effects such as on adaptive sampling methods based on image pyramids, handling spatially varying albedo, and shadowed and multiple-bounce indirect radiance. Moreover, extension to non-diffuse (but not highly specular) receivers can be made by applying low-frequency incident radiance Lₚ to other BRDFs.

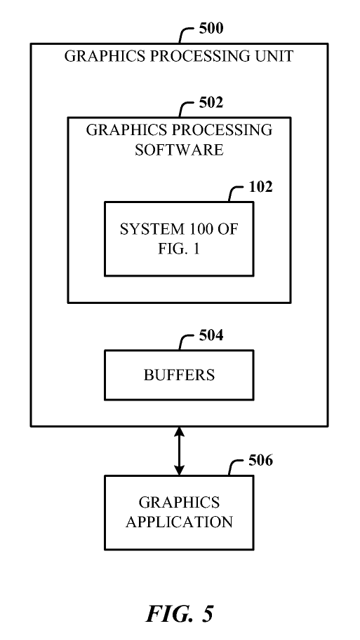

FIG. 5 illustrates a GPU 500 that can process image-based proxy accumulation for realtime soft global illumination. The GPU 500 can include software 502 that includes at least the system 100 of FIG. 1: the blocker component 102, the accumulation component 104 and the sampling component 106. The GPU 500 can also include buffers 504, which include the receiver buffer, proxy accumulation buffer and shading buffer, for example. The rendering pipeline employed in a graphics application 506 unifies direct and indirect lighting soft effects using one or more accumulation algorithms that map directly to the GPU 500.

Disclosed herein are flow charts representative of exemplary methodologies for performing novel aspects of the disclosed architecture. While, for purposes of simplicity of explanation, the one or more methodologies shown herein, for example, in the form of a flow chart or flow diagram, are shown and described as a series of acts, it is to be understood and appreciated that the methodologies are not limited by the order of acts, as some acts may, in accordance therewith, occur in a different order and/or concurrently with other acts from that shown and described herein. For example, those skilled in the art will understand and appreciate that a methodology could alternatively be represented as a series of interrelated states or events, such as in a state diagram. Moreover, not all acts illustrated in a methodology may be required for a novel implementation.

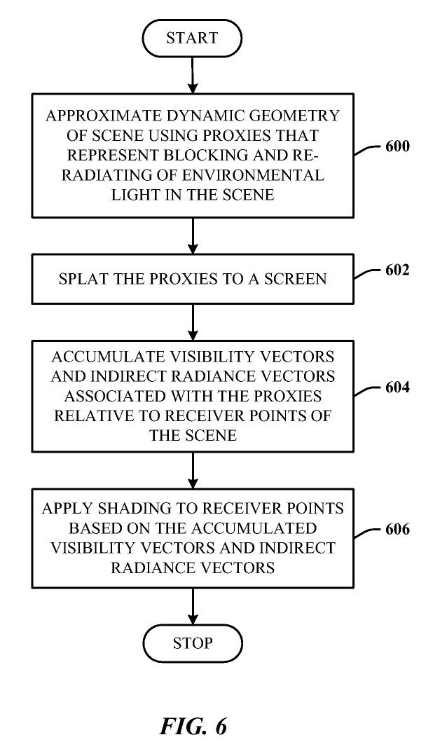

FIG. 6 illustrates a computer-implemented method of illuminating an image. At 600, dynamic geometry of a scene is approximated using proxy spheres that represent blocking and re-radiating of environmental light in the scene. At 602, the proxies are splatted to a screen. At 604, visibility vectors and indirect radiance vectors associated with the proxies are accumulated relative to receiver points of the scene. At 606, shading is applied to the receiver points based on the accumulated visibility vectors and indirect radiance vectors.

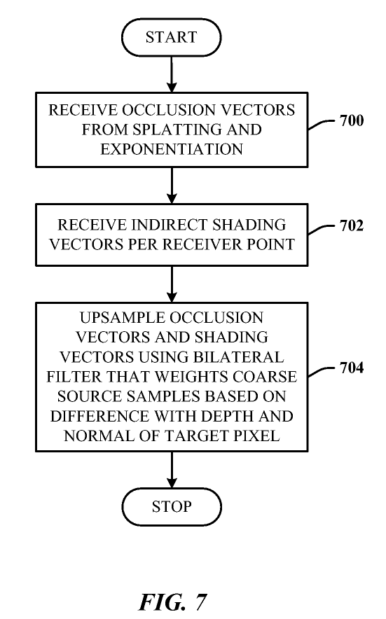

FIG. 7 illustrates a method of moving low-resolution lighting information to display resolution. At 700, occlusion vectors are received from splatting and exponentiation. These vectors are stored in the receiver buffer. At 702, indirect shading vectors per receiver point are accumulated. At 704, the occlusion vectors and indirect shading vectors are upsampled using bilateral filtering that weights coarse source samples based on the difference in depth and normal values of the target pixel (in image space).

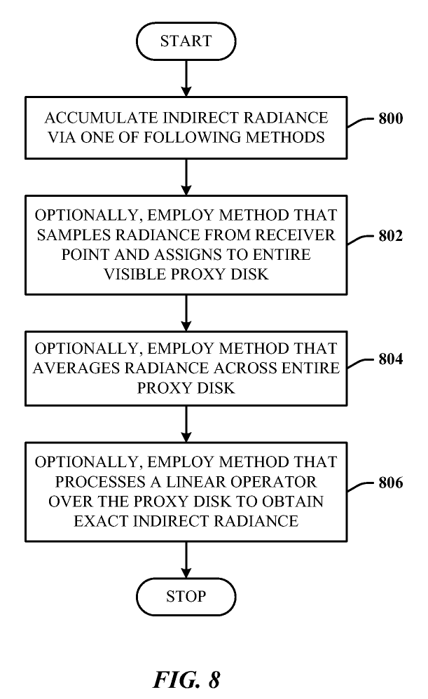

FIG. 8 illustrates a method of accumulating indirect radiance from a proxy sphere. At 800, one of at least three methods can be selected and employed. At 802, optionally, employ method that samples radiance from receiver point and assigns radiance to entire visible proxy disk. At 804, optionally, employ method that averages radiance across entire proxy disk. At 806, optionally, employ method that processes a linear operator over the proxy disk to obtain the exact indirect radiance.

As used in this application, the terms “component” and “system” are intended to refer to a computer-related entity, either hardware, a combination of hardware and software, software, or software in execution. For example, a component can be, but is not limited to being, a process running on a processor, a processor, a hard disk drive, multiple storage drives (of optical and/or magnetic storage medium), an object, an executable, a thread of execution, a program, and/or a computer. By way of illustration, both an application running on a server and the server can be a component. One or more components can reside within a process and/or thread of execution, and a component can be localized on one computer and/or distributed between two or more computers.

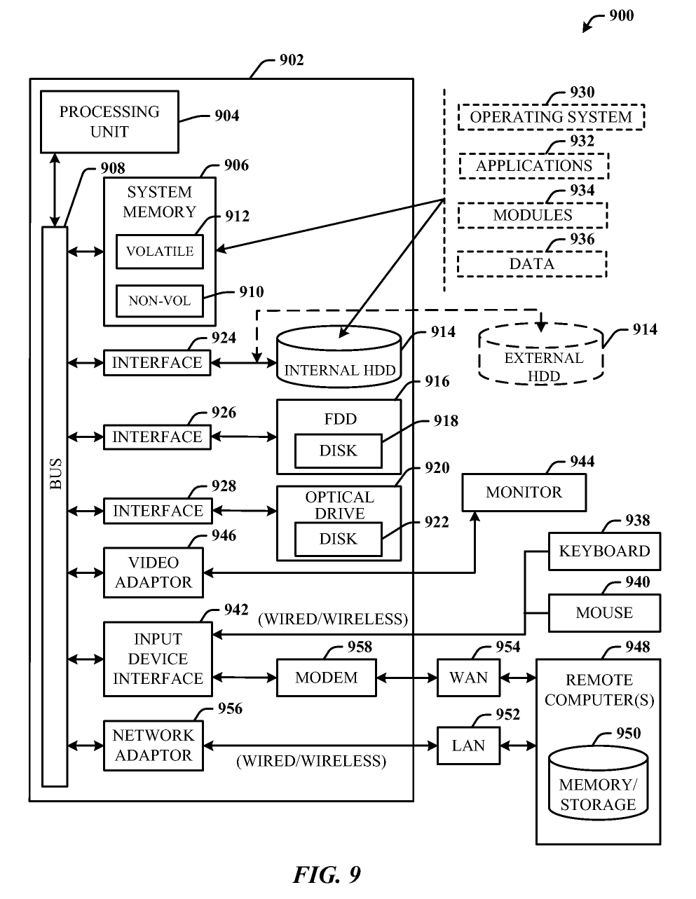

Referring now to FIG. 9, there is illustrated a block diagram of a computing system 900 operable to execute soft global illumination using image-based proxy accumulation in accordance with the disclosed architecture. In order to provide additional context for various aspects thereof, FIG. 9 and the following discussion are intended to provide a brief, general description of a suitable computing system 900 in which the various aspects can be implemented. While the description above is in the general context of computer-executable instructions that may run on one or more computers, those skilled in the art will recognize that a novel embodiment also can be implemented in combination with other program modules and/or as a combination of hardware and software.

Generally, program modules include routines, programs, components, data structures, etc., that perform particular tasks or implement particular abstract data types. Moreover, those skilled in the art will appreciate that the inventive methods can be practiced with other computer system configurations, including single-processor or multiprocessor computer systems, minicomputers, mainframe computers, as well as personal computers, hand-held computing devices, microprocessor-based or programmable consumer electronics, and the like, each of which can be operatively coupled to one or more associated devices.

The illustrated aspects can also be practiced in distributed computing environments where certain tasks are performed by remote processing devices that are linked through a communications network. In a distributed computing environment, program modules can be located in both local and remote memory storage devices.

A computer typically includes a variety of computer-readable media. Computer-readable media can be any available media that can be accessed by the computer and includes volatile and non-volatile media, removable and non-removable media. By way of example, and not limitation, computer-readable media can comprise computer storage media and communication media. Computer storage media includes volatile and non-volatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital video disk (DVD) or other optical disk storage, magnetic cassettes, magnetic tape, magnetic disk storage or other magnetic storage devices, or any other medium which can be used to store the desired information and which can be accessed by the computer.

With reference again to FIG. 9, the exemplary computing system 900 for implementing various aspects includes a computer 902 having a processing unit 904, a system memory 906 and a system bus 908. The system bus 908 provides an interface for system components including, but not limited to, the system memory 906 to the processing unit 904. The processing unit 904 can be any of various commercially available processors. Dual microprocessors and other multi-processor architectures may also be employed as the processing unit 904.

The system bus 908 can be any of several types of bus structure that may further interconnect to a memory bus (with or without a memory controller), a peripheral bus, and a local bus using any of a variety of commercially available bus architectures. The system memory 906 can include non-volatile memory (NON-VOL) 910 and/or volatile memory 912 (e.g., random access memory (RAM)). A basic input/output system (BIOS) can be stored in the non-volatile memory 910 (e.g., ROM, EPROM, EEPROM, etc.), which BIOS contains the basic routines that help to transfer information between elements within the computer 902, such as during start-up. The volatile memory 912 can also include a high-speed RAM such as static RAM for caching data.

The computer 902 further includes an internal hard disk drive (HDD) 914 (e.g., EIDE, SATA), which internal HDD 914 may also be configured for external use in a suitable chassis, a magnetic floppy disk drive (FDD) 916, (e.g., to read from or write to a removable diskette 918) and an optical disk drive 920, (e.g., reading a CD-ROM disk 922 or, to read from or write to other high capacity optical media such as a DVD). The HDD 914, FDD 916 and optical disk drive 920 can be connected to the system bus 908 by a HDD interface 924, an FDD interface 926 and an optical drive interface 928, respectively. The HDD interface 924 for external drive implementations can include at least one or both of Universal Serial Bus (USB) and IEEE 1394 interface technologies.

The drives and associated computer-readable media provide nonvolatile storage of data, data structures, computer-executable instructions, and so forth. For the computer 902, the drives and media accommodate the storage of any data in a suitable digital format. Although the description of computer-readable media above refers to a HDD, a removable magnetic diskette (e.g., FDD), and a removable optical media such as a CD or DVD, it should be appreciated by those skilled in the art that other types of media which are readable by a computer, such as zip drives, magnetic cassettes, flash memory cards, cartridges, and the like, may also be used in the exemplary operating environment, and further, that any such media may contain computer-executable instructions for performing novel methods of the disclosed architecture.

A number of program modules can be stored in the drives and volatile memory 912, including an operating system 930, one or more application programs 932, other program modules 934, and program data 936. The one or more application programs 932, other program modules 934, and program data 936 can include the blocker component 102, accumulation component 104, sampling component 106, rendering pipeline 300 and graphics application 506, for example.

All or portions of the operating system, applications, modules, and/or data can also be cached in the volatile memory 912. It is to be appreciated that the disclosed architecture can be implemented with various commercially available operating systems or combinations of operating systems.

A user can enter commands and information into the computer 902 through one or more wire/wireless input devices, for example, a keyboard 938 and a pointing device, such as a mouse 940. Other input devices (not shown) may include a microphone, an IR remote control, a joystick, a game pad, a stylus pen, touch screen, or the like. These and other input devices are often connected to the processing unit 904 through an input device interface 942 that is coupled to the system bus 908, but can be connected by other interfaces such as a parallel port, IEEE 1394 serial port, a game port, a USB port, an IR interface, etc.

A monitor 944 or other type of display device is also connected to the system bus 908 via an interface, such as a video adaptor 946. The video adaptor 946 can be the GPU 500 and include the graphics processing software 502 and buffers 504, for example. In addition to the monitor 944, a computer typically includes other peripheral output devices (not shown), such as speakers, printers, etc.

The computer 902 may operate in a networked environment using logical connections via wire and/or wireless communications to one or more remote computers, such as a remote computer(s) 948. The remote computer(s) 948 can be a workstation, a server computer, a router, a personal computer, portable computer, microprocessor-based entertainment appliance, a peer device or other common network node, and typically includes many or all of the elements described relative to the computer 902, although, for purposes of brevity, only a memory/storage device 950 is illustrated. The logical connections depicted include wire/wireless connectivity to a local area network (LAN) 952 and/or larger networks, for example, a wide area network (WAN) 954. Such LAN and WAN networking environments are commonplace in offices and companies, and facilitate enterprise-wide computer networks, such as intranets, all of which may connect to a global communications network, for example, the Internet.

When used in a LAN networking environment, the computer 902 is connected to the LAN 952 through a wire and/or wireless communication network interface or adaptor 956. The adaptor 956 can facilitate wire and/or wireless communications to the LAN 952, which may also include a wireless access point disposed thereon for communicating with the wireless functionality of the adaptor 956.

When used in a WAN networking environment, the computer 902 can include a modem 958, or is connected to a communications server on the WAN 954, or has other means for establishing communications over the WAN 954, such as by way of the Internet. The modem 958, which can be internal or external and a wire and/or wireless device, is connected to the system bus 908 via the input device interface 942. In a networked environment, program modules depicted relative to the computer 902, or portions thereof, can be stored in the remote memory/storage device 950. It will be appreciated that the network connections shown are exemplary and other means of establishing a communications link between the computers can be used.

The computer 902 is operable to communicate with any wireless devices or entities operatively disposed in wireless communication, for example, a printer, scanner, desktop and/or portable computer, portable data assistant, communications satellite, any piece of equipment or location associated with a wirelessly detectable tag (e.g., a kiosk, news stand, restroom), and telephone. This includes at least Wi-Fi and Bluetooth™ wireless technologies. Thus, the communication can be a predefined structure as with a conventional network or simply an ad hoc communication between at least two devices.

What has been described above includes examples of the disclosed architecture. It is, of course, not possible to describe every conceivable combination of components and/or methodologies, but one of ordinary skill in the art may recognize that many further combinations and permutations are possible. Accordingly, the novel architecture is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A computer-implemented illumination system, comprising:
a blocker component for approximating dynamic geometry of a scene using blocker proxies that represent lighting effects by the geometry at a receiver point in the scene; and
an accumulation component for splatting each blocker proxy to a receiver pixel in image space to accumulate shadowing and indirect lighting contribution of the blocker proxy at the receiver pixel.

2. The system of claim 1, wherein the blocker proxies are spherical proxies and the lighting effects are computed as logarithmic visibility vectors of the spherical proxies, the accumulation of which capture low-frequency directional dependence of environmental light.

3. The system of claim 1, further comprising a sampling component for sampling at less than a display resolution and then upsampling the lighting effects to image space based on occlusion vectors and indirect shading.

4. The system of claim 1, wherein the accumulation component accumulates logarithmic visibility vectors of the lighting effects from all directions at the receiver point from all blocker proxies using a spherical harmonic basis to represent shadowing, and accumulates indirect radiance vectors at the receiver point from all the blocker proxies.

5. The system of claim 1, further comprising a coverage oracle for bounding a sphere of influence of a blocker proxy.

6. The system of claim 5, wherein the each blocker proxy splat covers multiple pixels and a depth of each covered pixel is tested to determine if a corresponding receiver point is inside the sphere of influence.

7. The system of claim 1, wherein the lighting effects of a blocker proxy that are indirect are approximated based on a sampling of radiance arriving at a blocker proxy disk.

8. The system of claim 1, wherein the lighting effects of a blocker proxy that are indirect are averaged over an entire blocker proxy disk.

9. The system of claim 1, wherein the lighting effects of a blocker proxy that are indirect are computed using a linear operator which yields an exact spherical function for radiance over the blocker proxy.

10. A computer-implemented method of illuminating an image, comprising:
approximating dynamic geometry of a scene using proxies that represent blocking and re-radiating of environmental light in the scene;
splatting the proxies to a screen;
accumulating visibility vectors and indirect radiance vectors associated with the proxies relative to receiver points of the scene; and
applying shading to the receiver points based on the accumulated visibility vectors and indirect radiance vectors.

11. The method of claim 10, further comprising upsampling shading results using bilateral filtering based on the scene.

12. The method of claim 10, further comprising sampling at less than display resolution to accelerate rendering.

13. The method of claim 10, wherein the visibility vectors are logarithmic and the indirect radiance vectors are associated with unshadowed radiance of the proxies when illuminated by the environmental light.

14. The method of claim 10, further comprising processing all directions of the receiver points simultaneously using a spherical harmonic basis.

15. The method of claim 10, further comprising computing shadowing of multiple proxies using a sum of spherical harmonic functions.

16. The method of claim 10, further comprising bounding a sphere of influence for each of the proxies.

17. The method of claim 10, further comprising accumulating indirect radiance based on an approximation that pastes radiance sampled a center of the proxies over an associated entire visible disk.

18. The method of claim 10, further comprising accumulating indirect radiance based on an approximation that averages shading across the entire proxy.

19. The method of claim 10, further comprising accumulating indirect radiance based on a linear operator that produces an exact radiance distribution.

20. A computer-implemented system, comprising:
computer-implemented means for approximating dynamic geometry of a scene using sphere proxies that represent blocking and re-radiating of environmental light in the scene;
computer-implemented means for splatting the sphere proxies to a receiver pixel in an image to collect contribution of the proxy shadows to receiver points;
computer-implemented means for accumulating visibility vectors and indirect radiance vectors associated with the proxies; and
computer-implemented means for applying shading to the receiver points of the scene based on the visibility vectors and the indirect radiance vectors.
